(19) United States
(12) Patent Application Publication
(10) Pub. No.: US 2024/0135793 A1
(43) Pub. Date: Apr. 25, 2024

(54) ACOUSTO-MAGNETIC (AM) ANTI-THEFT MARKER AND USE THEREOF

(71) Applicant: Ningbo Signatronic Technologies, Ltd., Ningbo (CN)

(72) Inventors: Lin Li, Ningbo (CN); Caishan Lu, Ningbo (CN); Caobin LIU, Ningbo (CN)

(21) Appl. No.: 18/403,795

(22) Filed: Jan. 4, 2024

Related U.S. Application Data
(63) Continuation of application No. PCT/CN23/85821, filed on Apr. 2, 2023.

(30) Foreign Application Priority Data
Apr. 1, 2022 (CN) 202210358452.1

(51) Int. Cl. G08B 13/24

(52) U.S. Cl. CPC G08B 13/2422; G08B 13/2442

(57) ABSTRACT

The present disclosure discloses an acousto-magnetic (AM) anti-theft marker and use thereof. The AM anti-theft marker includes at least one resonator(s), where when the resonator(s) does not include cobalt, a weight percentage of nickel is 0 wt % to 39 wt %; or when the resonator(s) includes cobalt, a total weight percentage of nickel and cobalt is higher than 0 wt % and no more than 36 wt %. Although this AM anti-theft marker's resonator(s) of the present disclosure does not include or only includes a very small amount of nickel and cobalt, it still has good alarm performance; and the existing detectors can effectively detect the AM anti-theft marker of the present disclosure within a predetermined security alarming distance. It can be seen that this AM anti-theft marker has a commercial value, and can reduce the loss prevention cost of business and the consumption of earth resources.

### CROSS REFERENCE TO RELATED APPLICATIONS

The present application is a Continuation application of PCT Application No. PCT/CN2023/085821 filed on Apr. 2, 2023, which claims the benefit of Chinese Patent Application No. 202210358452.1 filed on Apr. 2, 2022. All the above are hereby incorporated by reference in their entirety.

### TECHNICAL FIELD

The present disclosure relates to the technical field of acousto-magnetic (AM) anti-theft devices, and in particular to an AM anti-theft marker and use thereof.

### BACKGROUND

The AM technology has been widely used in electronic article surveillance (EAS) anti-theft devices for more than thirty years. U.S. Pat. No. 4,510,489 recording an original invention discloses that some amorphous alloy material thin strips can emit strong resonance signals due to their high magneto-elastic coupling coefficients, and based on this principle, these materials are successfully used for markers in commercial anti-theft systems (AM systems), such as anti-theft systems for supermarkets. AM systems mainly include detectors, deactivators, anti-theft AM markers, and the like. The anti-theft AM markers can be divided into two types: anti-theft AM hard tags and anti-theft AM labels. The former adopts an amorphous strip(s) as the resonator(s) and a permanent magnetic material (such as a permanent ferrite bonded magnet, a bonded rare-earth permanent magnet, or a sintered rare-earth permanent magnet) as a bias, such anti-theft AM hard tags cannot be deactivated and can only be used repeatedly inside stores; and the latter also adopt the amorphous strip(s) as the resonator(s), and customarily adopt a specific semi-hard magnetic material (for example, a semi-hard magnetic material with a direct-current (DC) coercivity of 10 Oe to 55 Oe) as a bias, or adopt a soft-magnetic material with a DC coercivity of less than 10 Oe as a bias according to a previous technical solution from this applicant. Such AM anti-theft labels (hereinafter referred to as “AM labels” or “labels”) can be repeatedly deactivated and activated. An AM label on a paid good allows the good to leave a store without triggering an alarm at a door through demagnetization as deactivation.

An amorphous strip adopted by the AM anti-theft markers currently on the market has a composition in Fe—Ni—Mo—B system, in which a weight percentage (wt %) content of the relatively precious nickel (Ni) metal is about 42 wt % to 55 wt %. Nickel is a valuable industrial raw material with a price fluctuating greatly, and the preparation of nickel requires high electric energy consumption. Conventionally, it has always been believed that a high-nickel resonator is a guarantee for a marker to have high resonance amplitude and high alarm performance. For example, lines 23 to 28 of column 18 of U.S. Pat. No. 7,205,893 indicate that a Fe—Ni—Mo—B system with a Ni content of 35 at % to 48 at % in an atomic percentage (that is, about 42 wt % to 55 wt % in a weight percentage) is suitable as the resonator of an AM marker. Another amorphous strip composition is a Fe—Ni—Co—Si—B system, in which a total content of Co and Ni generally needs to reach about 40 wt % to 60 wt % in a weight percentage to achieve prominent alarm performance. For example, lines 30 to 34 of column 9 of U.S. Pat. No. 6,187,112 indicate that an atomic percentage (at %) of Co is 16 at % to 42 at % and an atomic percentage of Ni is 20 at % to 40 at %. Cobalt has scarcer earth reserves and is more precious than nickel, and thus needs to be used sparingly or not used. However, so far, there is no commercially available resonator amorphous strip with a nickel content of less than 39 wt % (in the absence of cobalt) or a cobalt+nickel total content of less than 36 wt % or no nickel at all on the market.

The AM anti-theft markers are indispensable security products for the current retail industry, with annual global consumption of AM markers in the order of tens of billions. It is extremely difficult to recover precious nickel (and cobalt) from these markers after being used. Therefore, it is an unremitting goal for those skilled in the art to develop AM anti-theft markers that include little or a small amount of nickel and cobalt, yet have alarm performances comparable to currently available AM anti-theft markers. Such novel AM anti-theft markers are of commercial value because they help to reduce loss prevention costs for businesses and thus have social and economic benefits.

### SUMMARY

An objective of the present disclosure is to overcome the deficiencies of the prior art and provide an AM anti-theft marker and use thereof. The resonator(s) in the AM anti-theft markers of the present disclosure either does not include any cobalt or nickel, or includes cobalt and nickel in greatly reduced amounts compared with the prior art. The alarm performance of invented AM anti-theft markers is not significantly reduced and these AM anti-theft markers can be used commercially. The invented AM markers help to reduce loss prevention costs for businesses and has economic and social benefits.

To achieve the above objective, the present disclosure adopts the following technical solutions:
An acousto-magnetic (AM) anti-theft marker is provided, including at least one resonator, where when the resonator(s) does(do) not include cobalt, a weight percentage of nickel is 0 wt % to 39 wt %; or
when the resonator(s) includes cobalt, a total weight percentage of nickel and cobalt is higher than 0 wt % and less than or equal to 36 wt %.

Further, an alarming distance of the AM anti-theft marker in an X direction is 72 cm to 90 cm; the X direction refers to a length direction of the AM anti-theft marker that is parallel to the ground and perpendicular to a surface of a detection antenna of a dual antenna Ultrapost system; a mounting distance between detection antennas of the dual antenna Ultrapost system is 6 feet or 1.8 m.

Preferably, the total weight percentage of nickel and cobalt in the resonator(s) is 0 wt % to 30 wt %.

Preferably, a weight percentage of nickel in the resonator(s) is 0 wt % to 19 wt %.

Preferably, a weight percentage of nickel in the resonator(s) is 0 wt % to 11 wt %.

Preferably, a weight percentage of nickel in the resonator(s) is 0 wt % to 5 wt %.

Preferably, a weight percentage of nickel in the resonator(s) is 0 wt % to 1 wt %.

Preferably, when the resonator(s) does not include cobalt, the weight percentage of nickel in the resonator(s) is 0 wt %.

Further, an alarming distance of the AM anti-theft marker in a Y direction is 20 cm to 40 cm; the Y direction refers to a length direction of the AM anti-theft marker that is parallel to the ground and parallel to a surface of a detection antenna of a dual antenna Ultrapost system; a mounting distance between detection antennas of the dual antenna Ultrapost system is 6 feet or 1.8 m.

Preferably, a weight percentage of nickel in the resonator(s) is 0 wt % to 20 wt %.

Preferably, a weight percentage of nickel in the resonator(s) is 0 wt % to 1 wt %.

Further, an alarming distance of the AM anti-theft marker in a Z direction is 40 cm to 65 cm; the Z direction refers to a length direction of the AM anti-theft marker that is perpendicular to the ground and parallel to a surface of a detection antenna of a dual antenna Ultrapost system; a mounting distance between detection antennas of the dual antenna Ultrapost system is 6 feet or 1.8 m.

Preferably, a weight percentage of nickel in the resonator(s) is 0 wt % to 30 wt %.

Preferably, a weight percentage of nickel in the resonator(s) is 0 wt % to 20 wt %.

Preferably, a weight percentage of nickel in the resonator(s) is 0 wt % to 10 wt %.

Preferably, a weight percentage of nickel in the resonator(s) is 0 wt % to 1 wt %.

Further, the resonator(s) further includes at least one selected from the group consisting of Mo, Cr, Mn, Nb, B, Si, V, C, and P.

Further, the AM anti-theft marker includes 1 to 6 resonator(s) each with a width of 2.3 mm to 7.0 mm.

Further, the AM anti-theft marker includes 2 to 6 resonators each with a width of 2.6 mm to 7.0 mm.

Further, the AM anti-theft marker includes 3 to 5 resonators each with a width of 2.3 mm to 6.8 mm.

The AM anti-theft marker further includes a resonator house, a resonator house cover, and a magnetic bias.

The present disclosure further provides an amorphous strip for preparing the AM anti-theft marker described above, where
when cobalt is not present in the amorphous strip, the amorphous strip includes the following elements in weight percentages:
Ni: 0 wt % to 39 wt %, Mo: 0 wt % to 12 wt %, Cr: 0 wt % to 4 wt %, Mn: 0 wt % to 3 wt %, Nb: 0 wt % to 3 wt %, X: 0 wt % to 5 wt %, B: 1 wt % to 5 wt %, Si: 0 wt % to 5 wt %, P: 0 wt % to 0.9 wt %, C: 0 wt % to 1 wt %, and Fe: the balance; or
when cobalt is present in the amorphous strip, the amorphous strip includes the following elements in weight percentages:
Ni+Co: higher than 0 wt % and less than or equal to 36 wt %, Mo: 0 wt % to 12 wt %, Cr: 0 wt % to 4 wt %, Mn: 0 wt % to 3 wt %, Nb: 0 wt % to 3 wt %, X: 0 wt % to 5 wt %, B: 1 wt % to 5 wt %, Si: 0 wt % to 5 wt %, P: 0 wt % to 0.9 wt %, C: 0 wt % to 1 wt %, and Fe: the balance,
where X is any one or more transition metals other than the metal elements listed above.

Preferably, a weight percentage of Ni in the amorphous strip is 0 wt % to 36 wt %.

Preferably, a weight percentage of Ni in the amorphous strip is 0 wt % to 19 wt %.

Preferably, a weight percentage of Ni in the amorphous strip is 0 wt % to 11 wt %.

Preferably, a weight percentage of Ni in the amorphous strip is 0 wt % to 5 wt %.

Preferably, a weight percentage of Ni in the amorphous strip is 0 wt % to 1 wt %.

Preferably, a weight percentage of Ni in the amorphous strip is 0 wt %, and a weight percentage of Co in the amorphous strip is higher than 0 wt % and less than or equal to 20 wt %.

The present disclosure further provides the resonator(s), including the amorphous strip described above.

The present disclosure further provides use of the AM anti-theft marker, the amorphous strip, or the resonator(s) described above in an AM anti-theft product.

Preferably, the AM anti-theft marker has a resonance frequency of 57.5 kHz to 58.5 kHz.

The applicant has been committed to achieving the economic and social benefit objectives discussed above through reducing nickel content in an amorphous strip of the resonator(s) (while maintaining low or zero cobalt content). After creative invention steps, the applicant determined that when the AM anti-theft marker of the present disclosure has at least one resonator, and when a weight percentage of nickel in the resonator(s) is 0 wt % to 39 wt % (in the absence of cobalt) or a total weight percentage of nickel and cobalt is higher than 0 wt % and less than or equal to 36 wt % (in the presence of cobalt), the AM anti-theft marker of the present disclosure can be effectively detected by existing AM anti-theft marker detectors (such as a dual antenna Ultrapost system) within a predetermined security alarming distance. The low-nickel (or nickel-free) and low-cobalt (or cobalt-free) resonator(s) used in the present disclosure show no significantly reduce the alarm performance of the invented AM anti-theft marker. As such, the invented AM anti-theft marker is of commercial value because it helps to reduce loss prevention costs for businesses. The goal of the inventor to produce a commercially viable AM anti-theft marker with reduced nickel and cobalt in the resonator(s) is achieved.

A lot of tests were conducted aiming at reducing nickel and cobalt in an amorphous strip without compromising the alarm performance of the AM markers. In the end, it was found that an amorphous strip with the composition specified above would not significantly reduce the alarm performance of the AM anti-theft marker, resulting in the following unexpected technical effects: contrary to the conventional belief that only amorphous strips with a high nickel content (in the absence of cobalt) or a high cobalt+nickel content can be used to prepare commercial AM anti-theft markers, the inventors determined that amorphous strips with a very low nickel (or even nickel and cobalt free) composition can be used to produce commercial AM anti-theft marker with good alarming performance. The AM anti-theft marker of the present disclosure is commercially viable.

### BRIEF DESCRIPTION OF THE DRAWINGS

FIG. 1 is a projection view of AM anti-theft markers according to an embodiment of the present disclosure in a dual antenna Ultrapost system (mounting distance between the detection antennas is 6 feet or 1.8 m) along the detection directions of X-Y-Z; and

FIG. 2 is a perspective view of the AM anti-theft markers according to an embodiment of the present disclosure in a dual antenna Ultrapost system (mounting distance between detection antennas is 6 feet or 1.8 m) along the detection directions of X-Y-Z.

### DETAILED DESCRIPTION

To better explain the objectives, technical solutions, and advantages of the present disclosure, the present disclosure will be further explained below with reference to the accompanying drawings and specific embodiments.

In the following embodiments, unless otherwise specified, the experimental methods used are conventional, and the materials and reagents used are commercially available. For example, strip preparation and heat treatment methods for an amorphous resonator(s), a method for preparing a 58 kHz AM anti-theft marker with the amorphous resonator(s) and a bias, and a test method of the AM anti-theft marker are all well known by those skilled in the art.

It is conventionally believed that a nickel content in the resonator(s) plays a very important role in the alarm performance of an AM anti-theft marker. It is generally believed in the field that, in order to make an AM anti-theft marker with satisfactory alarm performance, the nickel content in the resonator(s) of the AM anti-theft marker is usually controlled at 42 wt % to 55 wt % (in the absence of cobalt). At present, there are no nickel-free AM anti-theft markers commercially available, and it has not been reported in literature that the resonator(s) with a low total nickel and cobalt content (such as less than 36 wt %) or even no nickel can be used to prepare commercially viable AM anti-theft markers. It is conventionally believed that the resonator(s) with a low or zero nickel content cannot be used to prepare practical AM anti-theft markers with satisfactory alarm performance.

The present embodiment provides the following technical solutions that overcome the technical prejudice:

The present disclosure provides an amorphous strip for preparing an AM anti-theft marker,
when the amorphous strip does not include cobalt, the amorphous strip includes the following elements in weight percentages:
Ni: 0 wt % to 39 wt %, Mo: 0 wt % to 12 wt %, Cr: 0 wt % to 4 wt %, Mn: 0 wt % to 3 wt %, Nb: 0 wt % to 3 wt %, X: 0 wt % to 5 wt %, B: 1 wt % to 5 wt %, Si: 0 wt % to 5 wt %, P: 0 wt % to 0.9 wt %, C: 0 wt % to 1 wt %, and Fe: the balance; or
when the amorphous strip includes cobalt, the amorphous strip includes the following elements in weight percentages:
Ni+Co: higher than 0 wt % and less than or equal to 36 wt %, Mo: 0 wt % to 12 wt %, Cr: 0 wt % to 4 wt %, Mn: 0 wt % to 3 wt %, Nb: 0 wt % to 3 wt %, X: 0 wt % to 5 wt %, B: 1 wt % to 5 wt %, Si: 0 wt % to 5 wt %, P: 0 wt % to 0.9 wt %, C: 0 wt % to 1 wt %, and Fe: the balance,
where X is any one or more transition metals other than the metal elements listed above.

In an alternative embodiment, a material of the resonator(s) is a FeNiMoB (with a cobalt content of zero) or FeNiCoSiB (with a cobalt content of greater than zero) amorphous alloy. The elements can be selected from above weight percentage ranges according to actual requirements.

The AM anti-theft marker of the embodiment of the present disclosure includes at least one resonator(s), where when the resonator(s) does not include cobalt, a weight percentage of nickel is 0 wt % to 39 wt %; or when the resonator(s) includes cobalt, a total weight percentage of nickel and cobalt is higher than 0 wt % and less than or equal to 36 wt %.

Through creative efforts, the inventor determined that the resonator(s) of the present invention comprising zero cobalt and 0-39 wt % nickel has resonance signal strength, in contrast to conventional belief that resonance signal intensity of the resonator(s) would rapidly fall when nickel concentration is lower than 42-55 wt %. Similarly, when cobalt is present in the resonator(s) and a total weight percentage of nickel and cobalt is higher than 0 wt % and less than or equal to 36 wt %, the alarming distance of the AM anti-theft marker comprising the resonator(s) does not decrease significantly with the decrease of nickel and cobalt in the resonator(s), and the AM anti-theft marker can still be effectively detected by existing detection antennas within a predetermined security alarming distance. The common belief that a rise in a resonance signal's intensity positively correlates with an increase in the resonator(s)'s nickel (or nickel+cobalt) concentration is challenged by the current disclosure. In the present disclosure, when the resonator(s) is devoid of cobalt, a weight percentage of nickel is 0 wt % to 39 wt %; or when the resonator(s) comprises cobalt, a total weight percentage of nickel and cobalt is higher than 0 wt % and less than or equal to 36 wt %. Preferably, the resonator(s) comprises 0-<19 wt % nickel. In this way, the production costs and resource consumption of the AM anti-theft markers can be reduced without undermining the anti-theft ability.

In an alternative embodiment, a weight percentage of nickel in the resonator(s) is 0 wt % to 39 wt % (in the absence of cobalt), for example, the weight percentage of nickel in the resonator(s) is 0 wt %, 1 wt %, 5 wt %, 10 wt %, 11 wt %, 20 wt %, 21 wt %, 30 wt %, 36 wt %, 39 wt %, or the like. Of course, another value in this weight percentage range can also be selected according to actual requirements, which will not be repeated herein.

Those skilled in the field of AM anti-theft markers generally believe that a high-nickel (cobalt-free) or high-(nickel+cobalt) resonator(s) is a guarantee for a marker to have high resonance strength and excellent alarm performance. As a specific example, since AM markers were invented in 1982, no low-nickel (such as less than 19 wt %) or even both (nickel+cobalt) free resonator(s) with a commercial value has appeared on the market. Through creative efforts, the inventors discover that, when a weight percentage of nickel is 0 wt % to 39 wt % (in the absence of cobalt) or a total weight percentage of nickel and cobalt is higher than 0 wt % and less than or equal to 36 wt %, a resonance signal intensity of the resonator(s) of the AM marker (with an alarming distance of an existing commercial 58 kHz alarm as an actual index) does not decrease significantly or suddenly with the decrease in the nickel content, which breaks the conventional idea of the industry in the past few decades.

In an alternative embodiment, a width of the resonator(s) is 2.3 mm to 7.0 mm, for example, the width of the resonator(s) may be 2.3 mm, 2.6 mm, 6.8 mm, 7.0 mm, 4.2 mm, 4.5 mm, 3.0 mm, or the like. Of course, another value in this width range can also be selected according to actual requirements, which will not be repeated herein. In the embodiment of the present disclosure, the resonator(s) with a size smaller than a conventional size is adopted to meet the requirement of a customer for a narrow marker to protect a small delicate good, which reduces the consumption of a valuable resonator(s) amorphous material and reduces the raw material cost.

In an alternative embodiment, there are 1 to 6 resonator(s), which can specifically be 1, 2, 3, 4, 5, and 6 resonator(s). The required number of resonator(s)s can be determined according to actual use requirements.

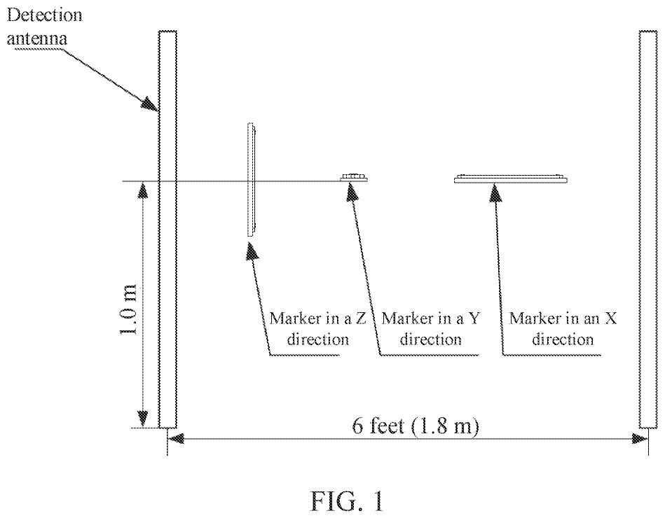

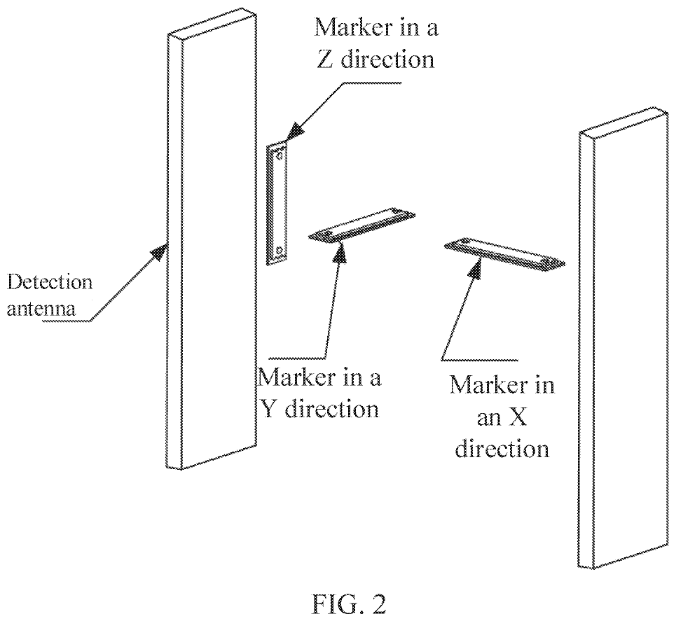

In a specific embodiment, the AM anti-theft marker can be detected by a commercially-available detector, for example, the detector may be a dual antenna Ultrapost system produced by Sensormatic that is commonly installed at various store doors, where a distance between centers of two antennas is 6 feet or 1.8 m. The marker of the present disclosure is detected at a height of 1 m above the ground, and detection directions of X-Y-Z are shown in FIG. 1 and FIG. 2. The marker is moving towards the closer surface of the Ultrapost detector, until an alarm is triggered, at which point a distance of a center of the marker to a surface of an alarm at a near end is measured as an alarming distance. An X direction refers to a length direction of the AM anti-theft marker that is parallel to the ground and perpendicular to a surface of a detection antenna of a dual antenna Ultrapost system. A Y direction refers to a length direction of the AM anti-theft marker that is parallel to the ground and parallel to a surface of a detection antenna of a dual antenna Ultrapost system. A Z direction refers to a length direction of the AM anti-theft marker that is perpendicular to the ground and parallel to a surface of a detection antenna of a dual antenna Ultrapost system.

In an embodiment of the present disclosure, an alarming distance of the AM anti-theft marker in a dual antenna Ultrapost system (mounting distance: 6 feet or 1.8 m) in the X direction is 72 cm to 90 cm; in an embodiment of the present disclosure, an alarming distance of the AM anti-theft marker in a dual antenna Ultrapost system (mounting distance: 6 feet or 1.8 m) in the Y direction is 20 cm to 40 cm; and in an embodiment of the present disclosure, an alarming distance of the AM anti-theft marker in a dual antenna Ultrapost system (mounting distance: 6 feet or 1.8 m) in the Z direction is 40 cm to 65 cm.

In order to facilitate the understanding of the above embodiments, test results of alarming distances of the AM anti-theft markers with different resonator(s)s are shown in Table 1 to Table 20. When measuring alarming distance data of the AM anti-theft markers, the AM anti-theft markers are allowed to move along an X, Y, or Z direction to shorten the distance between the AM anti-theft marker and the surface of a detection antenna proximal to the marker until the alarm is triggered. All elements are listed in weight percentages, wt %.

TABLE 1
(prior art)

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 90 | 26 | 55 |
| resonators: 3 | 2 | 90 | 25 | 60 |
| Width: 6.8 mm | 3 | 90 | 31 | 54 |
| Fe: the balance, | 4 | 90 | 27 | 61 |
| Ni: 48.9, | 5 | 90 | 30 | 58 |
| Mo: 7.6, | 6 | 90 | 28 | 60 |
| B: 3.9 | 7 | 90 | 34 | 53 |
| | 8 | 90 | 25 | 51 |
| | 9 | 90 | 20 | 60 |
| | 10 | 90 | 25 | 55 |
| | Average | 90 | 27.1 | 56.7 |

TABLE 2

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 90 | 14 | 55 |
| resonators: 3 | 2 | 90 | 20 | 56 |
| Width: 6.8 mm | 3 | 90 | 23 | 55 |
| Fe: the balance, | 4 | 90 | 20 | 56 |
| Ni: 45.8, | 5 | 90 | 18 | 56 |
| Mo: 11.2, and | 6 | 90 | 29 | 62 |
| B: 3.8 | 7 | 90 | 21 | 59 |
| | 8 | 90 | 23 | 53 |
| | 9 | 90 | 26 | 60 |
| | 10 | 90 | 28 | 52 |
| | Average | 90 | 22.2 | 56.4 |

TABLE 3

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 90 | 19 | 56 |
| resonators: 3 | 2 | 90 | 22 | 55 |
| Width: 6.8 mm | 3 | 90 | 21 | 54 |
| Fe: the balance, | 4 | 90 | 29 | 56 |
| Ni: 42.1, | 5 | 90 | 25 | 56 |
| Mo: 7.7, and | 6 | 90 | 20 | 50 |
| B: 3.9 | 7 | 90 | 23 | 60 |
| | 8 | 90 | 21 | 53 |
| | 9 | 90 | 21 | 55 |
| | 10 | 90 | 26 | 51 |
| | Average | 90 | 22.7 | 54.6 |

TABLE 4

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 90 | 27 | 54 |
| resonators: 3 | 2 | 90 | 21 | 59 |
| Width: 6.8 mm | 3 | 90 | 21 | 62 |
| Fe: the balance, | 4 | 90 | 12 | 61 |
| Ni: 38.9, | 5 | 90 | 32 | 64 |
| Mo: 7.3, | 6 | 90 | 38 | 62 |
| Cr: 0.5, and | 7 | 90 | 37 | 59 |
| B: 3.9 | 8 | 90 | 25 | 60 |
| | 9 | 90 | 28 | 34 |
| | 10 | 90 | 23 | 60 |
| | Average | 90 | 26.4 | 57.5 |

TABLE 5

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 90 | 27 | 64 |
| resonators: 3 | 2 | 90 | 28 | 61 |
| Width: 6.8 mm | 3 | 90 | 25 | 59 |
| Fe: the balance, | 4 | 90 | 29 | 63 |
| Ni: 36.1, | 5 | 90 | 25 | 60 |
| Mo: 6.3, | 6 | 90 | 26 | 61 |
| Cr: 1.5, and | 7 | 90 | 27 | 61 |
| B: 3.9 | 8 | 90 | 28 | 60 |
| | 9 | 90 | 24 | 65 |
| | 10 | 90 | 30 | 62 |
| | Average | 90 | 26.9 | 61.6 |

TABLE 6

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 90 | 24 | 55 |
| resonators: 3 | 2 | 90 | 23 | 58 |
| Width: 6.8 mm | 3 | 90 | 16 | 50 |
| Fe: the balance, | 4 | 90 | 25 | 64 |
| Ni: 30.2, | 5 | 90 | 23 | 46 |
| Mo: 6.8, | 6 | 90 | 26 | 52 |
| Cr: 0.9, | 7 | 90 | 11 | 39 |
| B: 3.3, and | 8 | 90 | 23 | 43 |
| Si: 0.6 | 9 | 90 | 19 | 41 |
| | 10 | 90 | 13 | 53 |
| | Average | 90 | 20.3 | 50.1 |

TABLE 7

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 90 | 13 | 45 |
| resonators: 3 | 2 | 90 | 20 | 45 |
| Width: 6.8 mm | 3 | 88 | 23 | 44 |
| Fe: the balance, | 4 | 89 | 20 | 44 |
| Ni: 24.8, | 5 | 90 | 15 | 40 |
| Mo: 6.8, | 6 | 90 | 21 | 57 |
| Cr: 0.9, | 7 | 90 | 20 | 57 |
| B: 2.7, | 8 | 90 | 21 | 60 |
| Si: 0.6, and | 9 | 90 | 22 | 53 |
| P: 0.5 | 10 | 90 | 14 | 54 |
| | Average | 89.7 | 18.9 | 49.9 |

TABLE 8

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 78 | 18 | 47 |
| resonators: 3 | 2 | 84 | 19 | 49 |
| Width: 6.8 mm | 3 | 80 | 19 | 46 |
| Fe: the balance, | 4 | 76 | 15 | 48 |
| Ni: 14.7, | 5 | 88 | 7 | 54 |
| Mo: 7.6, | 6 | 79 | 9 | 47 |
| Cr: 0.9, | 7 | 82 | 8 | 49 |
| B: 3.7, and | 8 | 77 | 11 | 48 |
| Si: 0.8 | 9 | 85 | 17 | 40 |
| | 10 | 82 | 8 | 47 |
| | Average | 81.1 | 13.1 | 47.5 |

TABLE 9

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 72 | 8 | 41 |
| resonators: 3 | 2 | 72 | 12 | 42 |
| Width: 6.8 mm | 3 | 74 | 14 | 44 |
| Fe: the balance, | 4 | 77 | 7 | 43 |
| Mo: 5.4, | 5 | 75 | 11 | 53 |
| Cr: 3.9, | 6 | 73 | 18 | 49 |
| B: 3.9, and | 7 | 76 | 11 | 41 |
| Si: 0.2 | 8 | 78 | 20 | 43 |
| | 9 | 66 | 13 | 39 |
| | 10 | 74 | 15 | 40 |
| | Average | 73.7 | 12.9 | 43.5 |

TABLE 10

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 71 | 10 | 49 |
| resonators: 2 | 2 | 73 | 12 | 45 |
| Width: 6.8 mm | 3 | 76 | 6 | 44 |
| Fe: the balance, | 4 | 76 | 18 | 48 |
| Ni: 14.7, | 5 | 78 | 16 | 43 |
| Mo: 7.6, | 6 | 80 | 17 | 51 |
| Cr: 0.9, | 7 | 73 | 11 | 45 |
| B: 3.7, and | 8 | 83 | 8 | 51 |
| Si: 0.8 | 9 | 78 | 20 | 50 |
| | 10 | 73 | 19 | 43 |
| | Average | 76.1 | 13.7 | 46.9 |

TABLE 11

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 61 | 9 | 28 |
| resonators: 2 | 2 | 72 | 11 | 38 |
| Width: 6.8 mm | 3 | 69 | 6 | 42 |
| Fe: the balance, | 4 | 68 | 8 | 39 |
| Mo: 5.4, | 5 | 76 | 14 | 50 |
| Cr: 3.9, | 6 | 71 | 10 | 40 |
| B: 3.9, and | 7 | 67 | 11 | 35 |
| Si: 0.2 | 8 | 83 | 6 | 49 |
| | 9 | 75 | 12 | 47 |
| | 10 | 73 | 10 | 42 |
| | Average | 71.5 | 9.7 | 41 |

TABLE 12

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 61 | 15 | 20 |
| resonators: 1 | 2 | 68 | 26 | 27 |
| Width: 7.0 mm | 3 | 68 | 22 | 29 |
| Fe: the balance, | 4 | 65 | 24 | 41 |
| Ni: 36.1, | 5 | 60 | 19 | 40 |
| Mo: 6.3, | 6 | 56 | 21 | 41 |
| Cr: 1.5, and | 7 | 69 | 26 | 40 |
| B: 3.9 | 8 | 60 | 24 | 33 |
| | 9 | 63 | 22 | 35 |
| | 10 | 64 | 21 | 40 |
| | Average | 63.4 | 22 | 34.6 |

TABLE 13

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 53 | 18 | 24 |
| resonators: 1 | 2 | 59 | 15 | 21 |
| Width: 7.0 mm | 3 | 55 | 14 | 34 |
| Fe: the balance, | 4 | 55 | 13 | 29 |
| Ni: 24.8, | 5 | 59 | 10 | 28 |
| Mo: 6.8, | 6 | 60 | 13 | 39 |
| Cr: 0.9, | 7 | 51 | 15 | 35 |
| B: 2.7, | 8 | 49 | 15 | 39 |
| Si: 0.6, and | 9 | 55 | 13 | 30 |
| P: 0.5 | 10 | 50 | 12 | 28 |
| | Average | 54.6 | 13.8 | 30.7 |

TABLE 14

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 90 | 38 | 52 |
| resonators: 4 | 2 | 90 | 40 | 52 |
| Width: 4.2 mm | 3 | 90 | 35 | 52 |
| Fe: the balance, | 4 | 90 | 38 | 50 |
| Ni: 45.8, | 5 | 90 | 38 | 50 |
| Mo: 11.2, and | 6 | 90 | 39 | 47 |
| B: 3.8 | 7 | 90 | 40 | 48 |
| | 8 | 90 | 40 | 52 |
| | 9 | 90 | 39 | 52 |
| | 10 | 90 | 40 | 55 |
| | Average | 90 | 38.7 | 51 |

TABLE 15

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 90 | 20 | 49 |
| resonators: 4 | 2 | 90 | 22 | 45 |
| Width: 4.5 mm | 3 | 90 | 16 | 56 |
| Fe: the balance, | 4 | 90 | 20 | 47 |
| Ni: 30.1, | 5 | 90 | 20 | 55 |
| Mn: 1.5, | 6 | 90 | 22 | 46 |
| Mo: 7.3, | 7 | 90 | 23 | 54 |
| Nb: 0.8, and | 8 | 90 | 22 | 51 |
| B: 3.8 | 9 | 90 | 20 | 53 |
| | 10 | 90 | 22 | 58 |
| | Average | 90 | 20.7 | 51.4 |

TABLE 16

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 70 | 20 | 26 |
| resonators: 3 | 2 | 63 | 19 | 35 |
| Width: 3.0 mm | 3 | 69 | 21 | 34 |
| Fe: the balance, | 4 | 72 | 19 | 25 |
| Ni: 38.9, | 5 | 60 | 16 | 30 |
| Mo: 7.3, | 6 | 64 | 25 | 32 |
| Cr: 0.5, and | 7 | 69 | 17 | 28 |
| B: 3.9 | 8 | 63 | 26 | 29 |
| | 9 | 62 | 19 | 26 |
| | 10 | 70 | 20 | 24 |
| | Average | 66.2 | 20.2 | 28.9 |

TABLE 17

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 32 | 13 | 23 |
| resonators: 3 | 2 | 27 | 12 | 23 |
| Width: 3.0 mm | 3 | 31 | 13 | 22 |
| Fe: the balance, | 4 | 40 | 12 | 22 |
| Ni: 24.8, | 5 | 32 | 10 | 21 |
| Mo: 6.8, | 6 | 28 | 9 | 19 |
| Cr: 0.9, | 7 | 38 | 11 | 20 |
| B: 2.7, | 8 | 34 | 10 | 18 |
| Si: 0.6, and | 9 | 33 | 12 | 16 |
| P: 0.5 | 10 | 46 | 13 | 15 |
| | Average | 34.0 | 11.5 | 19.9 |

TABLE 18

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 82 | 11 | 57 |
| resonators: 5 | 2 | 80 | 14 | 50 |
| Width: 2.6 mm | 3 | 83 | 21 | 55 |
| Fe: the balance, | 4 | 89 | 15 | 56 |
| Ni: 42.1, | 5 | 84 | 10 | 57 |
| Mo: 7.7, and | 6 | 82 | 11 | 49 |
| B: 3.9 | 7 | 78 | 10 | 53 |
| | 8 | 71 | 17 | 56 |
| | 9 | 77 | 9 | 52 |
| | 10 | 81 | 12 | 54 |
| | Average | 80.7 | 13 | 53.9 |

TABLE 19

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 72 | 11 | 45 |
| resonators: 6 | 2 | 75 | 9 | 46 |
| Width: 2.3 mm | 3 | 73 | 12 | 46 |
| Fe: the balance, | 4 | 69 | 10 | 42 |
| Mo: 5.4, | 5 | 73 | 10 | 43 |
| Cr: 3.9, | 6 | 72 | 8 | 50 |
| B: 3.9, and | 7 | 73 | 11 | 44 |
| Si: 0.2 | 8 | 70 | 10 | 47 |
| | 9 | 75 | 9 | 45 |
| | 10 | 72 | 11 | 43 |
| | Average | 72.4 | 10.1 | 45.1 |

TABLE 20

| | | Alarming | Alarming | Alarming |
|---|---|---|---|---|
| | | distance of | distance of | distance of |
| | | a marker | a marker | a marker |
| | | in an X | in a Y | in a Z |
| resonator(s) | | direction | direction | direction |
| properties | No. | (cm) | (cm) | (cm) |
| Number of | 1 | 80 | 13 | 48 |
| resonators: 4 | 2 | 76 | 14 | 45 |
| Width: 4.2 mm | 3 | 75 | 12 | 50 |
| Fe: the balance, | 4 | 78 | 18 | 42 |
| Ni: 5, | 5 | 73 | 15 | 48 |
| Co: 7, | 6 | 81 | 13 | 52 |
| Mo: 4.2, | 7 | 76 | 12 | 43 |
| Cr: 3.5, | 8 | 75 | 17 | 49 |
| B: 3.1, and | 9 | 78 | 12 | 45 |
| Si: 0.8 | 10 | 79 | 15 | 53 |
| | Average | 77.1 | 14.1 | 47.5 |

It can be seen from the comparison between Table 1 (prior art) and Tables 2 to 9 (technique of the present disclosure) that, when the number of resonators (three) and the width (6.8 mm) are the same and a material of the resonators is a FeNiMoB amorphous alloy, with the decrease in a weight percentage of nickel, an alarming distance of the AM anti-theft marker does not monotonically decrease, and is not rapidly drops as conventionally thought. The alarming distance can still be acceptable commercially in the low-Ni or no Ni compositions. In particular, it can be seen from Table 9 that, when a nickel-free sample is in the X direction, an alarming distance reaches about 74 cm, that is, an effective protection width can reach about 1.5 m, which exceeds a width of a radio frequency (RF) anti-theft system (another EAS protection system usually with an installation distance of 1 m) widely used on the market. Such a nickel-free and cobalt-free AM marker has a cost close to or lower than a cost of an RF marker (which also has an annual global consumption of tens of billions), meanwhile exhibits advantages on anti-metal shielding or anti-liquid shielding effect over the RF marker, which cannot exhibit an anti-metal shielding or anti-liquid shielding effect. Also RF markers generally has a bigger area than AM marker's. In reality, many of the AM systems worldwide are now installed at a width of about 1.5 m. Therefore, the low-nickel or nickel-free AM marker of the present disclosure has become commercially valuable in terms of high ratio of performance vs cost.

Tables 11 to 19 (technique of the present disclosure) show experimental data obtained under different compositions and different resonator(s) widths and numbers. Similar to Table 9, Table 11 and Table 19 show that, under two wide resonators and six narrow resonators, an alarming distance of a nickel-free sample in the X-direction can also reach about 72 cm to 73 cm, that is, an effective protection width can also reach about 1.5 m, which has promising commercial prospects. Other low-nickel samples exhibit a similar technical effect, that is, low-nickel and nickel-free samples can also lead to these AM anti-theft markers as practical products.

Table 20 (technique of the present disclosure) shows four narrow resonators with low-nickel and low-cobalt compositions, and an alarming distance in the X-direction also reaches 77 cm, that is, a protection width can reach about 1.6 m, which also has acceptable alarm performance.

In addition, in some embodiments of the present disclosure, four types of AM anti-theft markers (each including four 4.5 mm width resonators are prepared from the following amorphous compositions: Fe: the balance, Ni: 1.6, Mo: 7.3, Nb: 1.1, Cr: 0.39, Si: 0.6, and B: 4.0; Fe: the balance, Ni: 6.8, Mo: 7.5, Nb: 0.9, Cu: 0.8, and B: 3.9; Fe: the balance, Ni: 7.5, Mo: 7.5, Nb: 0.9, Cu: 0.6, and B: 3.9; and Fe: the balance, Ni: 8.1, Mo: 7.1, Nb: 1.2, Cr: 0.9, Si: 0.5, B: 3.2, and P: 0.6; and resonators of the four compositions have a resonance frequency range of 57.5 kHz to 58.5 kHz, an alarming distance thereof in the X direction can reach 75 cm to 85 cm, and an effect thereof is relatively stable. The X direction refers to a length direction of the AM anti-theft marker that is parallel to the ground and perpendicular to a surface of a detection antenna of the dual antenna Ultrapost system (with a mounting distance of 6 feet or 1.8 m).

For the AM anti-theft marker in each embodiment of the present disclosure, a weight percentage of nickel in the resonator(s) is controlled to be 0 wt % to 39 wt % (in the absence of cobalt), or a total weight percentage of nickel and cobalt is controlled to be higher than 0 wt % and less than or equal to 36 wt % (in the presence of cobalt). It can be seen from the above detection data that, an alarming distance of the AM anti-theft marker in the dual antennas detector Ultrapost (a distance between centers of the two antennas is 6 feet or 1.8 m) in the X direction is 72 cm to 90 cm; an alarming distance in the Y direction is 20 cm to 40 cm; and an alarming distance in the Z direction is 40 cm to 65 cm. That is, the AM anti-theft marker of the present disclosure can be effectively detected by the existing detection antenna for AM anti-theft markers within a predetermined security alarming distance. Therefore, it has been tested that the AM anti-theft marker provided by an embodiment of the present disclosure has an unexpected technical effect, and can overcome the existing technical bias that a nickel-free or low-nickel AM anti-theft marker cannot be normally commercialized. When a weight percentage of nickel in the resonator(s) is reduced to 0 wt % to 39 wt % (in the absence of cobalt) or a total weight percentage of nickel and cobalt is controlled to be higher than 0 wt % and less than or equal to 36 wt % (in the presence of cobalt), and in particular, when a nickel content is reduced to 19 wt % or less, a material cost of the AM anti-theft marker can be greatly reduced, and the large electric energy consumption required for nickel electrolysis and the cost waste and environmental pollution of mining, processing, and transportation are reduced, which continuously contributes to the global environmental protection.

In summary, each embodiment of the present disclosure provides an amorphous strip, the resonator(s), and an AM anti-theft marker thereof; when a weight percentage of nickel in the resonator(s) is controlled to be 0 wt % to 39 wt % (in the absence of cobalt) or a total weight percentage of nickel and cobalt is controlled to be higher than 0 wt % and less than or equal to 36 wt % (in the presence of cobalt), a resonance signal amplitude provided by the resonator(s) of the AM anti-theft marker does not decrease or rapidly decrease with the decrease of a nickel content, in contrast to conventional thought by skilled in the art. Instead, an alarming distance of the such AM anti-theft marker does not decrease significantly or suddenly with the decrease in a weight percentage of nickel; and in fact, the AM anti-theft marker still can be effectively detected by the existing AM detection antenna within a predetermined security alarming distance. By controlling a weight percentage of nickel in the resonator(s) to be 0 wt % to 39 wt % (in the absence of cobalt) or controlling a total weight percentage of nickel and cobalt in the resonator(s) to be higher than 0 wt % and less than or equal to 36 wt %, the present disclosure can greatly reduce a production cost of the AM anti-theft marker under the premise of ensuring its anti-theft performance.

Finally, it should be noted that the above embodiments are provided merely to describe the technical solutions of the present disclosure, rather than to limit the protection scope of the present disclosure. Although the present disclosure is described in detail with reference to preferred embodiments, a person of ordinary skill in the art should understand that modifications or equivalent replacements may be made to the technical solutions of the present disclosure. For example, try to use different proportions, additions, or removal of elements other than nickel and cobalt, but as long as a content of nickel (cobalt-free) or a total content of cobalt and nickel in the amorphous resonator(s) for the AM anti-theft marker is reduced to a value within a scope of each claim of the present disclosure: or try to modify or use equivalent replacement with AM anti-theft alarming systems of other commercial brands through different mounting modes, resulting same or equivalent alarming distances, those do not depart from the spirit and scope of the technical solutions of the present disclosure.

1. An acousto-magnetic (AM) anti-theft marker, comprising at least one resonator(s), wherein when the resonator(s) is devoid of cobalt, a weight percentage of nickel is 0 wt % to 39 wt %; or
when the resonator(s) comprises cobalt, a total weight percentage of nickel and cobalt is higher than 0 wt % and less than or equal to 36 wt %.

2. The AM anti-theft marker according to claim 1, wherein an alarming distance of the AM anti-theft marker in an X direction is 72 cm to 90 cm; the X direction refers to a length direction of the AM anti-theft marker that is parallel to the ground and perpendicular to a surface of a detection antenna of a dual antenna Ultrapost system; a mounting distance between detection antennas of the dual antenna Ultrapost system is 6 feet or 1.8 m.

3. The AM anti-theft marker according to claim 1, wherein the total weight percentage of nickel and cobalt in the resonator(s) is 0 wt % to 30 wt %.

4. The AM anti-theft marker according to claim 1, wherein a weight percentage of nickel in the resonator(s) is 0 wt % to 19 wt %.

5. The AM anti-theft marker according to claim 1, wherein a weight percentage of nickel in the resonator(s) is 0 wt % to 5 wt %.

6. The AM anti-theft marker according to claim 1, wherein a weight percentage of nickel in the resonator(s) is 0 wt % to 1 wt %.

7. The AM anti-theft marker according to claim 1, wherein when the resonator(s) is devoid of cobalt, the weight percentage of nickel in the resonator(s) is 0 wt %.

8. The AM anti-theft marker according to claim 1, wherein an alarming distance of the AM anti-theft marker in a Y direction is 20 cm to 40 cm; the Y direction refers to a length direction of the AM anti-theft marker that is parallel to the ground and parallel to a surface of a detection antenna of a dual antenna Ultrapost system; a mounting distance between detection antennas of the dual antenna Ultrapost system is 6 feet or 1.8 m.

9. The AM anti-theft marker according to claim 8, wherein a weight percentage of nickel in the resonator(s) is 0 wt % to 20 wt %.

10. The AM anti-theft marker according to claim 1, wherein an alarming distance of the AM anti-theft marker in a Z direction is 40 cm to 65 cm; the Z direction refers to a length direction of the AM anti-theft marker that is perpendicular to the ground and parallel to a surface of a detection antenna of a dual antenna Ultrapost system; a mounting distance between detection antennas of the dual antenna Ultrapost system is 6 feet or 1.8 m.

11. The AM anti-theft marker according to claim 10, wherein a weight percentage of nickel in the resonator(s) is 0 wt % to 30 wt %.

12. The AM anti-theft marker according to claim 1, wherein the resonator(s) further comprises at least one selected from the group consisting of Mo, Cr, Mn, Nb, B, Si, V, C, and P.

13. The AM anti-theft marker according to claim 1, wherein the AM anti-theft marker comprises 1 to 6 resonator(s)s each with a width of 2.3 mm to 7.0 mm.

14. The AM anti-theft marker according to claim 13, wherein the AM anti-theft marker comprises 3 to 5 resonators each with a width of 2.3 mm to 6.8 mm.

15. The AM anti-theft marker according to claim 1, further comprising a resonator house, a resonator house cover, and a magnetic bias.

16. An amorphous strip for preparing the AM anti-theft marker according to claim 1, wherein when cobalt is not present in the amorphous strip, the amorphous strip comprises the following elements in weight percentages:
Ni: 0 wt % to 39 wt %, Mo: 0 wt % to 12 wt %, Cr: 0 wt % to 4 wt %, Mn: 0 wt % to 3 wt %, Nb: 0 wt % to 3 wt %, X: 0 wt % to 5 wt %, B: 1 wt % to 5 wt %, Si: 0 wt % to 5 wt %, P: 0 wt % to 0.9 wt %, C: 0 wt % to 1 wt %, and Fe: the balance; or
when cobalt is present in the amorphous strip, the amorphous strip comprises the following elements in weight percentages:
Ni+Co: higher than 0 wt % and less than or equal to 36 wt %, Mo: 0 wt % to 12 wt %, Cr: 0 wt % to 4 wt %, Mn: 0 wt % to 3 wt %, Nb: 0 wt % to 3 wt %, X: 0 wt % to 5 wt %, B: 1 wt % to 5 wt %, Si: 0 wt % to 5 wt %, P: 0 wt % to 0.9 wt %, C: 0 wt % to 1 wt %, and Fe: the balance, wherein X is any one or more transition metals other than the metal elements listed above.

17. The amorphous strip according to claim 16, wherein a weight percentage of Ni in the amorphous strip is 0 wt % to 36 wt %.

18. The amorphous strip according to claim 16, wherein a weight percentage of Ni in the amorphous strip is 1 wt % to 11 wt %.

19. The amorphous strip according to claim 16, wherein a weight percentage of Ni in the amorphous strip is 0 wt %, and a weight percentage of Co in the amorphous strip is higher than 0 wt % and less than or equal to 20 wt %.

20. The AM anti-theft marker according to claim 1, wherein the AM anti-theft marker has a resonance frequency of 57.5 kHz to 58.5 kHz.
